(19) United States
(12) Patent Application Publication
(10) Pub. No.: US 2010/0073244 A1
(43) Pub. Date: Mar. 25, 2010

(54) Apparatus Comprising a Radio Antenna Element and a Grounded Conductor

(76) Inventors: Ping Hui, Richmond (CA); Sassan Iraji, Espoo (FI); Joni Jorma Marius Jantunen, Helsinki (FI)

Correspondence Address: HARRINGTON & SMITH, 4 RESEARCH DRIVE, Suite 202, SHELTON, CT, 06484-6212, US

(21) Appl. No.: 12/448,488

(22) PCT Filed: Dec. 22, 2006
(86) PCT No.: PCT/IB2006/004177

§ 371 Date: Nov. 9, 2009

(51) Int. Cl. H01Q 1/24

(52) U.S. Cl. 343/702

(57) ABSTRACT

An apparatus including: an exterior housing; a radio antenna element within the exterior housing; and a grounded conductor extending adjacent the antenna element and having a first area that is physically associated with a portion of the exterior housing.

### FIELD OF THE INVENTION

Embodiments of the present invention relate to a radio apparatus.

### BACKGROUND TO THE INVENTION

Some radio apparatuses have an antenna element and a grounded conductor that operates as a ground plane for the grounded conductor.

The ground plane is an important component of such apparatus. To maximize the efficiency of the antenna element the ground plane must be sufficiently large. This constraint on the size of the ground plane may make it difficult to reduce the size of such radio apparatus.

### BRIEF DESCRIPTION OF THE INVENTION

According to some embodiments of the invention there is provided an apparatus comprising: an exterior housing; a radio antenna element within the exterior housing; and a grounded conductor extending adjacent the antenna element and having a first area that is physically associated with a portion of the exterior housing.

In use, a user's hand may touch or come close to the first area because of the physical association between the first area of the grounded conductor and the exterior housing. The user's hand, in use, increases the size of the grounded conductor improving antenna radiation efficiency.

According to some embodiments of the invention there is provided a portable apparatus comprising: an exterior housing; and an antenna arrangement comprising a radio antenna element within the exterior housing and a grounded conductor extending adjacent the antenna element and having a first area that is arranged such that it is coupled to the exterior housing to a significantly greater degree that the radio antenna element such that when the apparatus is held in a hand of a user the electrical length of the grounded conductor is significantly extended improving the efficiency of the antenna arrangement.

In some embodiments, the presence of the user's hand does not significantly change the impedance of the antenna element so that the antenna element is operable in the same communications band with or without the presence of the hand, although it is more efficient with the presence of the hand.

### BRIEF DESCRIPTION OF THE DRAWINGS

For a better understanding of the present invention reference will now be made by way of example only to the accompanying drawings in which:

FIG. 1 schematically illustrates a first embodiment of an apparatus;

FIG. 2 schematically illustrates a second embodiment of an apparatus;

FIG. 3 schematically illustrates a third embodiment of an apparatus;

FIG. 4 schematically illustrates a fourth embodiment of an apparatus; and

FIG. 5 schematically illustrates the effect of a user's hand on the efficiency of the apparatus.

### DETAILED DESCRIPTION OF EMBODIMENTS OF THE INVENTION

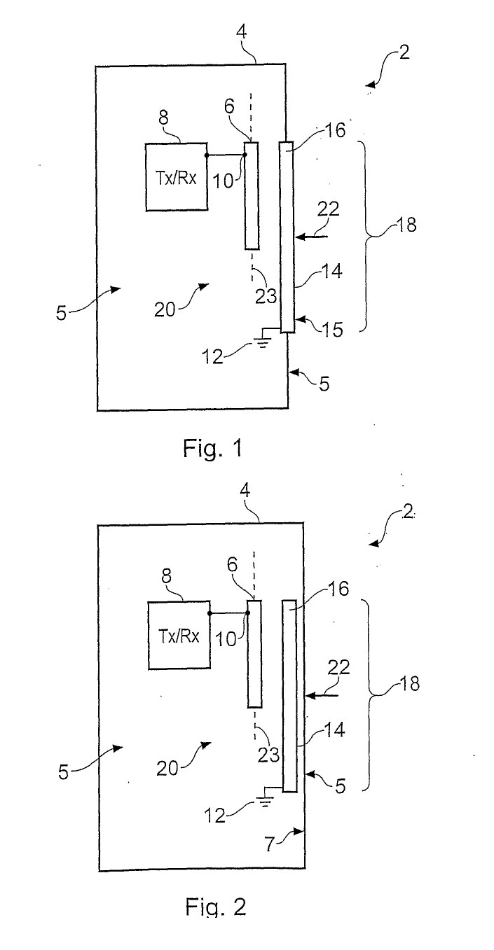

FIGS. 1, 2, 3 and 4 schematically illustrate an apparatus 2 comprising: an exterior housing 4; an antenna arrangement 20 comprising a radio antenna element 6 and a grounded conductor 14 and RF circuitry 8 connected to the radio antenna element 6.

The RF circuitry 8 may be a receiver, a transmitter or a transceiver depending upon implementation.

The radio antenna element 6 is positioned within a volume 5 enclosed by the exterior housing 4. It has a feed point 10 connected to the RF circuitry 8. It is not, in this example, in physical or electrical contact with exterior housing 4.

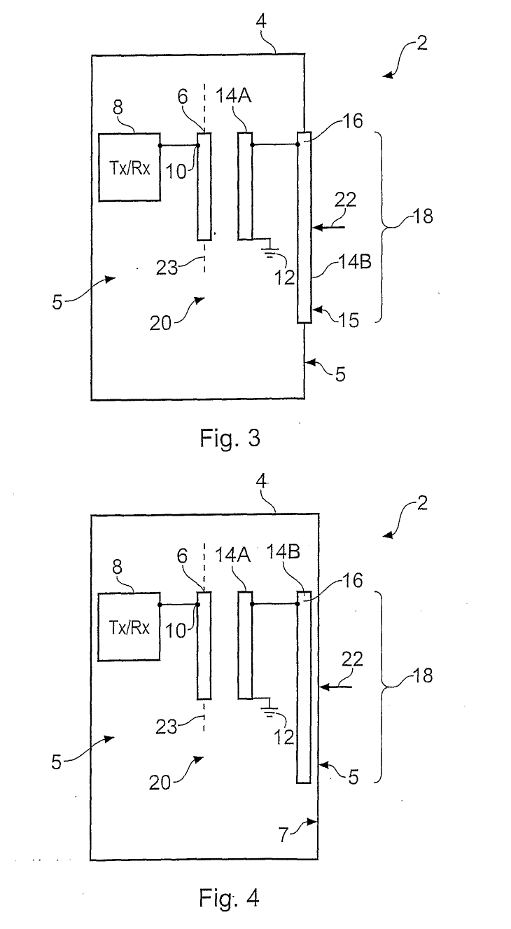

The exterior housing 4 has a portion 18 that typically makes contact with a user's hand when the apparatus 4 is in use. The portion 18 of the exterior housing 4 is coupled to ground in each of the embodiments illustrated in FIGS. 1 to 4. In FIGS. 1 and 3, a dc current path to ground is provided via the grounded conductor as the grounded conductor 14 provides the portion 18 of the exterior housing. In FIGS. 2 and 4, an ac current path to ground is provided via a capacitor formed by the grounded conductor 14, the dielectric portion 18 and the user's hand 22.

The grounded conductor 14 operates as a ground plane for the antenna element 6 and extends adjacent at least the feed point 10 of the radio antenna element 6. In some embodiments, the antenna element 6 may extend substantially in a first plane 23 from the feed point with the separate grounded conductor 14 running in parallel.

A first area 16 of the grounded conductor 14 is arranged such that it is electrically coupled to an exterior of the housing 4 to a significantly greater degree than the radio antenna element 6. The grounded conductor 14 is positioned closer to an exterior of the apparatus 2 than the radio antenna element 6.

When a hand 22 of a user contacts the portion 18 of the exterior housing 4, in use, the electrical length of the grounded conductor 6 is significantly increased. This increase in the ground plane of the antenna element 6 improves the efficiency of the antenna arrangement 20 at its lowest resonant frequency whereas the impedance of the antenna element 6 is not significantly changed at this frequency.

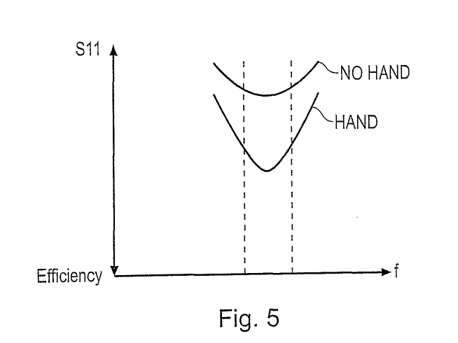

As illustrated in FIG. 5, the insertion loss S11 is more negative when a hand is in contact with the portion 18 of the exterior housing 4. As is well known to a person skilled in the art, a more negative insertion loss S11 corresponds to an improved efficiency. Thus the antenna arrangement 20 is more efficient when a user's hand is touching the portion 18 of the exterior housing 4.

It can also be seen from the Figure that, in this particular example, the resonant frequency of the antenna arrangement does not change or change significantly because the radio antenna element 6 is positioned and arranged such that coupling, in use, to a user's hand 22 is small or minimal. The presence of the user's hand does not significantly affect the electrical length or impedance of the antenna element 6 so that the antenna arrangement is operable in the same communications band with or without the presence of the user's hand but is more efficient with the presence of the user's hand.

In other embodiments the presence of a user's hand may significantly affect the electrical length or impedance of the antenna element 6. In these circumstances, the antenna arrangement may only be operable in a communications band with the presence of the user's hand.

In some embodiments, the grounded conductor 14 may operate as a separate antenna element particularly at lower frequencies. It is possible that the ground plane is effectively operating as a planar inverted F antenna that is capacitively fed from the antenna element 6.

In FIGS. 1 and 3, the grounded conductor 14 is associated with the exterior housing 14 by incorporation therein. The grounded conductor 14 is incorporated within the exterior housing 4 such that an exterior surface 15 of the grounded conductor 14 is an exterior surface 5 of the exterior housing 4. It is an integral and exposed part of the exterior housing 4. The grounded conductor 14 is galvanically connected to ground 12. When a user 22 touches the grounded conductor 14 the user is connected to ground via a galvanic (dc) current path that includes the grounded conductor 14. The user thus becomes part of the grounded conductor 14 extending the ground plane of the antenna element 6.

In FIGS. 2 and 4, the grounded conductor 14 is associated with the exterior housing 14 by being positioned very close to the portion 18 of the exterior housing 4. The grounded conductor 14 forms one plate of a capacitor, the other plate being formed by the user's hand 22 and the exterior housing providing the capacitor dielectric. The grounded conductor 14 may be attached or bonded to the interior surface 7 of the exterior housing 4 so that it is an integral but not exposed part of the exterior housing 4 or there may be a small air gap between them. When a user 22 touches the portion 18 of the exterior housing 4, the user is connected to ground via an ac current path that includes the capacitor. The user thus becomes part of the grounded conductor 14 for higher frequencies.

In FIGS. 1 and 2, the grounded conductor 14 is a single element. It may, for example, be a sheet of metal lying in a single plane.

In FIGS. 3 and 4, the grounded conductor 14 is a multi-art element. Each part is a separate element and the elements are electrically connected. In the illustrated examples, two parts are shown but there may be additional parts in other implementations. One or more of the interconnected parts may be electrically connected to ground 12.

The grounded conductor 14 comprises a first portion 14B that is associated with the exterior housing 4 in one of the manners described above and a second portion 14A that is associated with the antenna element 6 and electrically connected to the first portion 14A.

Typically the first portion 14B of the grounded conductor 14 is positioned closer to an exterior of the apparatus than the antenna element 6 to ensure that when a user touches the apparatus 2 the coupling between user and grounded conductor 14 is significantly greater than any coupling between the user and the antenna element 6.

The second portion 14A may be a printed wiring board (PWB). If the ground plane of the antenna element 6 has λ/4 resonant modes then one would expect its lowest resonant frequency mode to be defined by L=λ/4, where L is the electrical length of the ground plane which we shall approximate to the physical length. If the electrical length of the ground plane in the absence of a user's hand is L1 and the extension to the ground plane provided by the presence of a user's hand is L2 then L1+L2=λ/4 or 4L1+4L2=λ. Thus the lowest resonant frequency mode has an equivalent wavelength that is significantly greater than four times the electrical length L1 of the grounded conductor 14.

It will be appreciated from the foregoing that embodiments of the invention enable the electrical length of a ground plane for an antenna element to be extended in use. This enables the apparatus 2 to have a shorter than ideal ground plane because its length will be extended in use.

The apparatus 2 is typically a hand-portable device that is held in the palm of the hand when in use.

The apparatus 2 may, for example, be an RFID reader. Such readers are operable to receive radio communications for a range of frequencies between 800 MHz and 1 GHz e.g. at 868 MHz or 915 MHz.

The apparatus 2 may, for example, be a mobile cellular telephone, a wireless local area network (WLAN) terminal, a Digital Video Broadcasting-Handled (DVB-H) mobile TV receiver, a Frequency Modulation (FM) radio receiver etc. DVB-H typically uses the frequency range 470 to 830 MHz. A FM radio receiver typically uses the frequency range 88-108 MHz.

The device dimensions of a DVB-H device or FM radio device are typically much smaller than the operating wavelength and the antenna element is of small dimension compared to wavelength.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising
an exterior housing;
a radio antenna element within the exterior housing; and
a grounded conductor extending adjacent the antenna element and having a first area that is physically associated with a portion of the exterior housing.

2. An apparatus as claimed in claim 1, comprising an antenna arrangement that comprises the radio antenna element and the grounded conductor, wherein the first area of the grounded conductor is arranged such that it is electrically coupled to the exterior housing to a significantly greater degree that the radio antenna element such that when a hand of a user contacts the portion of the exterior housing the electrical length of the grounded conductor is significantly increased improving the efficiency of the antenna arrangement at a first frequency whereas the impedance of the antenna element is not significantly changed at the first frequency.

3. An apparatus as claimed in claim 1, wherein the grounded conductor operates as a ground plane for the antenna element and increasing the electrical length of the grounded conductor extends the ground plane thereby increasing the efficiency of the antenna element.

4. An apparatus as claimed in claim 1, wherein the grounded conductor, in use, operates as a planar inverted F antenna that is capacitively fed from the antenna element.

5. An apparatus as claimed in claim 1, wherein the radio antenna element has a feed point and the grounded conductor extends adjacent at least the feed point of the radio antenna element.

6. An apparatus as claimed in claim 1, having a first operational frequency that has an equivalent wavelength that is significantly greater than four times the length of the grounded conductor.

7. An apparatus as claimed in claim 1, wherein the radio antenna element is positioned and arranged such that coupling, in use, to a user's hand does not affect the electrical length of the antenna element.

8. An apparatus as claimed in claim 1, wherein the grounded conductor is positioned closer to the exterior of the apparatus than the radio antenna element.

9. An apparatus as claimed in claim 1, wherein the grounded conductor is physically attached to the exterior housing.

10. An apparatus as claimed in claim 1, wherein the grounded conductor is integrated within the exterior housing.

11. An apparatus as claimed in claim 1, wherein the grounded conductor comprises a first portion that is associated with the exterior housing and a second portion that is associated with the antenna element and electrically connected to the first portion.

12. An apparatus as claimed in claim 11, wherein the first portion of the grounded conductor is positioned closer to an exterior of the apparatus than the antenna element.

13. An apparatus as claimed in claim 1, wherein the radio antenna element extends substantially in a first plane and the first area of the grounded conductor extends substantially parallel to the first plane.

14. An apparatus as claimed in claim 13, wherein
the radio antenna element extends from a feed point substantially in the first plane and the first area extends adjacent to, but separated from, at least the feed point of the antenna element.

15. An apparatus as claimed in claim 1, wherein at least a portion of the exterior housing is coupled to ground, and wherein the coupling to ground is provided by capacitive coupling that involves the grounded conductor, and wherein the exterior housing forms a dielectric for a capacitor formed in use between the grounded conductor and the user's hand.

16. (canceled)

17. (canceled)

18. An apparatus as claimed in claim 1, wherein at least a portion of the exterior housing is coupled to the ground and wherein the coupling to ground is provided by a galvanic connection that comprises the grounded conductor.

19. An apparatus as claimed claim 1, wherein a surface portion of the exterior housing provides the grounded conductor.

20. An apparatus as claimed in claim 1 that is hand-portable.

21. An apparatus as claimed in claim 1 that is an apparatus selected from the group comprising:
an apparatus arranged for use as a RFID reader; an apparatus arranged for DVB-H communication; an apparatus arranged for FM radio communications; or an apparatus operable to receive radio communications for a range of frequencies between 800 MHz and 1 GHz.

22. (canceled)

23. (canceled)

24. (canceled)

25. A portable apparatus comprising:
an exterior housing; and
an antenna arrangement comprising a radio antenna element within the exterior housing and
a grounded conductor extending adjacent the antenna element and having a first area that is arranged such that it is coupled to the exterior housing to a significantly greater degree that the radio antenna element such that when the apparatus is held in a hand of a user the electrical length of the grounded conductor is significantly extended improving the efficiency of the antenna arrangement

26. (canceled)

27. (canceled)

28. (canceled)

29. (canceled)
